(19) United States
(12) Patent Application Publication
(10) Pub. No.: US 2018/0253733 A1
(43) Pub. Date: Sep. 6, 2018

(54) IN-HOME PRODUCT RECALL NOTIFICATION SYSTEM AND METHOD

(71) Applicant: Walmart Apollo, LLC, Bentonville, AR (US)

(72) Inventors: Steven J. Lewis, Bentonville, AR (US); Anthony G. Wind, III, Gravette, AR (US); Richard A. White, Pineville, MO (US); Todd D. Mattingly, Bentonville, AR (US)

(21) Appl. No.: 15/906,995

(22) Filed: Feb. 27, 2018

Related U.S. Application Data
(60) Provisional application No. 62/465,897, filed on Mar. 2, 2017.

(51) Int. Cl. G06Q 30/00; H04W 4/80; H04L 12/58

(52) U.S. Cl. CPC G06Q 30/014; H04W 4/80; G06F 17/30368; H04L 51/38; H04L 51/10

(57) ABSTRACT

In some embodiments, apparatuses, and methods are provided herein useful to providing recall notifications. In some embodiments, a system for providing recall notifications comprises a plurality of receivers, wherein the plurality of receivers are located about a customer's property, and wherein the plurality of receivers are configured to receive communications from transmitters associated with products within the customer's property, and a control circuit communicatively coupled to the plurality of receivers and configured to receive, from one or more of the plurality of receivers, an identifier, log, in a database, an indication of the identifiers and an indication of the customer, receive a recall notification, wherein the recall notification indicates at least one product, determine that the identifier is associated with the at least one product, determine, based on the database, that the customer possesses the at least one product, and transmit, to the customer, an indication of the recall notification.

### CROSS-REFERENCE TO RELATED APPLICATION

This application claims the benefit of U.S. Provisional Patent Application Ser. No. 62/465,897, filed Mar. 2, 2017, entitled IN-HOME PRODUCT RECALL NOTIFICATION SYSTEM AND METHOD, which is incorporated by reference in its entirety herein.

### TECHNICAL FIELD

This invention relates generally to product recall notifications and, more specifically, to in-home product recall notifications.

### BACKGROUND

Occasionally, products sold to customers are deemed unsafe or unsuitable for use after the customer has purchased the product. For example, a food product may be contaminated with an allergen or bacteria, or a children's toy may be prone to breakage that can result in choking. When products are found to be unsafe or unsuitable for use, a product recall is issued. The product recall can be issued by a manufacturer, supplier, retailer, and/or governmental agency. While product recalls typical include all relevant information related to the recall (e.g., product identification, reason for recall, etc.), the product recall is only effective if the customer is aware of it. Unfortunately, customers are often unaware of product recalls despite efforts by manufacturers, suppliers, retailers, and/or governmental agencies to inform the customers. Consequently, a need exists for better systems and methods for providing recall notifications to customers.

### BRIEF DESCRIPTION OF THE DRAWINGS

Disclosed herein are embodiments of systems, apparatuses, and methods pertaining to providing product recall notifications. This description includes drawings, wherein:

FIG. 1 is a conceptual diagram depicting a product recall notification system, according to some embodiments;

FIG. 2 is a block diagram of a system 200 for providing product recall notifications, according to some embodiments;

FIG. 3 is a flow diagram depicting example operations for providing product recall notifications, according to some embodiments; and

FIG. 4 is a flow diagram depicting example operations for providing product recall notifications, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to providing recall notifications.

In some embodiments, a system for providing recall notifications comprises a plurality of receivers, wherein the plurality of receivers are located about a customer's property, and wherein the plurality of receivers are configured to receive communications from transmitters associated with products within the customer's property, and a control circuit communicatively coupled to the plurality of receivers and configured to receive, in response to the customer bringing the products into the customer's property from one or more of the plurality of receivers, identifiers associated with the products, log, in a database, an indication of the identifiers and an indication of the customer, receive a recall notification, wherein the recall notification indicates at least one product, determine, based on the database, that the customer possess the at least one product, and transmit an indication of the recall notification for the at least one product.

As previously discussed, occasionally products sold to customers are deemed unsafe or unsuitable for use after the customer purchases the product. Customers are informed that the products have been deemed unsafe or unsuitable for use by product recall notifications (also referred to as “product recalls” or “recall notifications”). Typically, product recall notifications are sent to customers by a manufacturer, supplier, retailer, and/or governmental agency. Regardless of the entity sending the recall notification, the recall notification will only be effective if the customer actually receives it. For the customer to receive the recall notification, the entity sending the recall notification must have contact information for the customers that purchased the product, such as addresses, email addresses, phone numbers, etc. Often, the customer does not supply contact information when purchasing a product. Further, even if the customer does provide contact information at the time of purchase, someone other than the original customer may possess the product at the time of the recall. In either situation, it is difficult to provide the customer, or current owner, of a product with a recall notification.

Embodiments of the systems, methods, and apparatuses described herein seek to eliminate, or at least reduce, the difficulty in providing recall notifications to customers. In one embodiment, a system for providing recall notification can include radio frequency identification (RFID) readers located about a customer's property (e.g., the customer's home (house), office, etc.). When the customer brings products having RFID tags onto or near his or her property, the RFID readers read the RFID tags and logs an indication of the product in a database. When a product recall notification is issued, the system receives the recall notification and determines whether the customer possesses the product with which the recall is associated. If the customer possesses the product, an indication of the recall notification is transmitted to the customer. Because the system automatically tracks the products on the customer's property based on the RFID tags, the system is able to notify the customer even if the customer did not provide contact information at the time of purchase and/or if the customer is not the original purchaser of the product.

In other embodiments, a system able to eliminate, or at least reduce, the difficulty in providing recall notifications to customers utilizes receivers placed about a customer's property. The receives can be of any suitable type, such as low power radio frequency receivers. In such embodiments, there is not a need for a customer to have RFID readers inside or around his or her home. Instead, existing devices within the customer's home can be utilized to receive communications from transmitters associated with products. As one example, a product can include a Bluetooth transmitter and devices in the customer's home can include Bluetooth receivers. When the customer brings a product into his or her home, the Bluetooth transmitter associated with the product can communicate with the Bluetooth receiver in the customer's home. Much like in the example described above, the system can log an indication of the product in a database and alert the customer when a product recall notification is received. Because the system automatically tracks the products on the customer's property based on the transmitters associated with the products, the system is able to notify the customer even if the customer did not provide contact information at the time of purchase and/or if the customer is not the original purchaser of the product.

In a further embodiment, a system able to eliminate, or at least reduce, the difficulty in providing product recall notifications to customers utilizes a wireless network provided by, or accessible in, the customer's property. For example, a wireless network provided by the customer's property could be a Wi-Fi network and a wireless network accessible in the customer's property could be a wireless wide area network (WWAN). When the customer brings a product home, a transmitter associated with the product (e.g., a Wi-Fi radio or WWAN radio) can communicate with the wireless network. A wireless device in the customer's property (e.g., an access point) or a wireless device accessible in the customer's property (e.g., a cell tower) can receive communications from the transmitter. Much like in the example described above, the system can log an indication of the product in a database and alert the customer when a product recall notification is received. Because the system automatically tracks the products on the customer's property based on the transmitters associated with the products, the system is able to notify the customer even if the customer did not provide contact information at the time of purchase and/or if the customer is not the original purchaser of the product

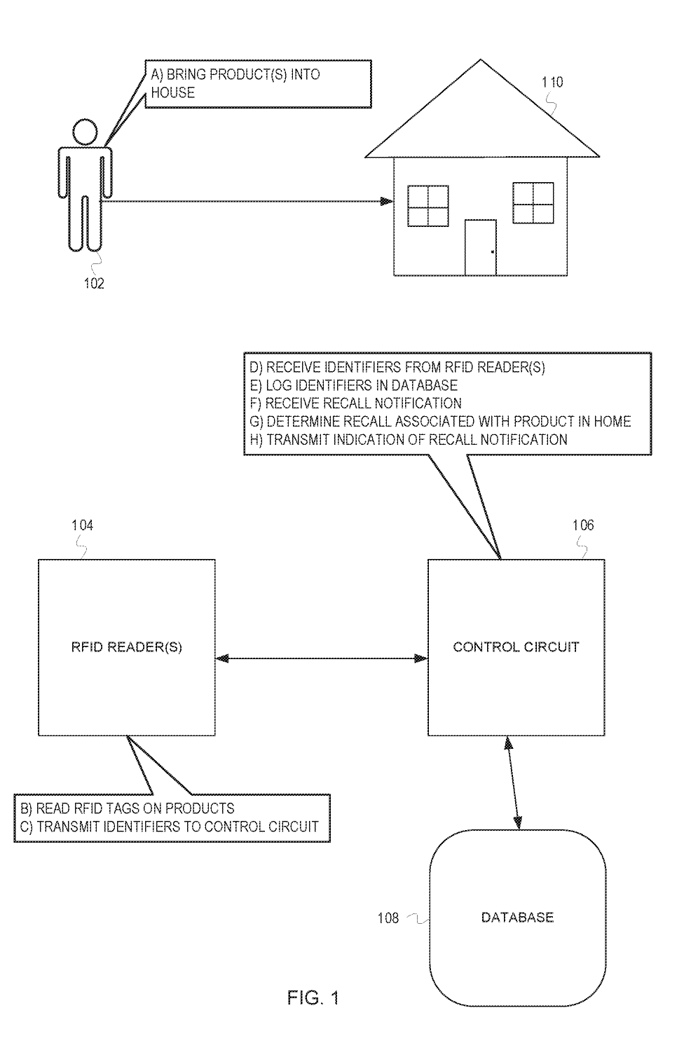

The discussion of FIG. 1 provides an overview of a system utilizing RFID readers located about a customer's property to facilitate receipt of product recall notifications.

FIG. 1 is a conceptual diagram depicting a product recall notification system, according to some embodiments. The system includes RFID readers 104, a control circuit 106, and a database 108. The RFID readers 104 are located about a customer's 102 property. In the conceptual diagram pictured in FIG. 1, the customer's 102 property is a house 110 and the RFID readers 104 are located in and around the customer's 102 house 110. Although depicted in FIG. 1 as RFID readers 104, in some embodiments, other types of receivers and/or transceivers can be used, such as low frequency radio frequency receivers/transceivers (e.g., Bluetooth, ZigBee, near field communication (NFC), etc. receivers/transceivers). In such embodiments, products can contain appropriate transmitters (e.g., Bluetooth transmitters) to communicate with the receivers and/or transceivers. Additionally, wireless network (e.g., Wi-Fi networks and/or WWANs can be used to receive communications from transmitters associated with products and allow the system to provide product recall notifications to customers. FIG. 1 depicts operations at stages A-H. The stages are examples and are not necessarily discrete occurrences over time (e.g., the operations of different stages may overlap). Additionally, FIG. 1 is an overview of example operations.

At stage A, the customer 102 brings products into his or her house 110. The customer 102 may have just purchased the products (i.e., the customer 102 may be the original purchaser) or the customer 102 may have received the product from someone else (e.g., purchased the product from, or been given the product by, the original purchaser). It should be noted that the customer 102 does not necessarily need to bring the product into the house 110. For example, if the product is of the type that is used outside (e.g., a gutter, flower pots, siding, etc.), at stage A the customer 102 may simply bring the product near his or her house 110.

At stage B, the RFID readers 104 read RFID tags on the products. The RFID readers 104 are located about the house 110. For example, the RFID readers 104 can be located in the house 110 as well as outside of the house 110. The RFID readers 104 can be of the standalone variety and placed about the house 110. Additionally, or alternatively, the RFID readers 104 can be integrated with appliances or other items or fixtures about the house 110. For example, a refrigerator may include one or more of the RFID readers 104, a closet may include one or more of the RFID readers 104, etc. The RFID readers 104 read RFID tags on the products when the products are within range of the RFID tags. For example, if the refrigerator includes one or more of the RFID readers 104, when the customer 102 places an item in the refrigerator, the one or more of the RFID tags in the refrigerator read the RFID tag of a product that is placed in the refrigerator. Additionally, if the house 110 includes RFID readers 104 in addition to the one or more RFID readers 104 in the refrigerator, the other RFID readers 104 may also read the RFID tag for the product before the customer 102 places the product in the refrigerator. In this regard, there may be multiple chances for an RFID tag to be read while the product is in or around the customer's 102 house 110.

At stage C, the RFID readers 104 transmit identifiers to the control circuit 106. When the RFID readers 104 read the RFID tags, the RFID readers 104 read identifiers from the RFID tags. The identifiers can be used to identify the product with which the RFID tag is associated, identify a manufacturer of the product with which the RFID tag is associated, identify a distributor of the product with which the RFID tag is associated, identify the retailer that sold the product with which the RFID tag is associated, etc. In some embodiments, this information is encoded in the RFID tag. In other embodiments, this information can be stored in a record which can be accessed to determine the information. The RFID readers 104 can transmit the identifiers to the control circuit 106 via any suitable communication mechanism. For example, if the control circuit 106 is local to the RFID readers 104 (i.e., the control circuit 106 is located at the house 110), the RFID readers 104 can transmit the identifiers to the control circuit 106 via Wi-Fi, near field communication (NFC), Bluetooth, power line communication (PLC), etc. If the control circuit 106 is remote from the RFID readers 104 (i.e., the control circuit 106 is not located at the house 110), the RFID readers 104 can transmit the identifiers to the control circuit 106 via a wide area network, such as the Internet or a wireless wide area network (WWAN).

At stage D, the control circuit 106 receives the identifiers from the RFID readers 104. Next, at stage E, the control circuit 106 logs the identifiers in the database 108. The control circuit 106 logs the identifiers in the database 108 such that the database 108 includes an association between the customer 102 and the product. For example, the database 108 can include an indication of the customer 102, each of the identifiers, date or time information relating to the first and/or last read or the identifier, etc. Like the control circuit 106, the database can be local to, or remote from, the RFID readers 104. In some embodiments, the control circuit 106 and the database 108 are both remote from the RFID readers 104. In such embodiments, the control circuit 106 may receive identifiers associated with products possessed by a number of customers. Accordingly, the database 108 would store associations between each of the number of customers and the products possessed by the customers. Alternatively, the control circuit 106 and/or the database 108 may be local to the RFID readers 104. In such embodiments, the database 108 may only store associations between the customer 102 and products that he or she possesses. It should be noted that regardless of the location of the control circuit 106 and/or the database 108, dependent upon the embodiment, the control circuit 106 and/or the database 108 may serve a single customer (e.g., the customer 102) or multiple customers.

At stage F, the control circuit 106 receives a recall notification. The control circuit 106 can receive the recall notification from any suitable party. For example, the control circuit 106 can receive the recall notification from a supplier, a manufacturer, a retailer, governmental agency, a business specializing in recall notifications, etc. In some embodiments, recall notifications are pushed to the control circuit 106. That is, the control circuit 106 receives the recall notifications without actively requesting or seeking the recall notifications. Push notifications may be beneficial in that the control circuit 106 is guaranteed to receive all recall notifications, regardless of whether the customer 102 possesses the product with which the recall notification is associated. Additionally, the control circuit 106 can store, for example in the database 108, some, or all, of the recall notifications received. In such embodiments, if the customer 102 brings a product home for which a recall notification is stored, the control circuit 106 will quickly be able to inform the customer 102. However, push notifications can also have potential drawbacks, such as providing the control circuit 106 with information that is not relevant to the customer 102. In other embodiments, the control circuit 106 may actively request, or pull, recall notifications. For example, the control circuit 106 could query manufacturer or supplier databases for recall notifications relating to products having identifiers stored in the database 108. The control circuit 106 may pull recall notifications regularly, such as hourly, daily, weekly, etc. While pull-type systems may limit the superfluous data received by the control circuit 106, they may be vulnerable to missed recall notifications.

At stage G, the control circuit 106 determines whether a received recall notification is associated with a product in the customer's 102 house 110. In embodiments in which recall notifications are pushed to the control circuit 106, the control circuit 106 may perform this task after the operations of stage F. In embodiments in which the control circuit 106 pulls recall notifications, the control circuit 106 may perform this task in conjunction with the operations of stage F. In either case, the control circuit 106 determines if the recall notifications are associated with any products in the customer's 102 house 110 based on the database 108. For example, if the recall notification is for Product X and one of the identifiers in the database is associated with Product X, the recall notification is associated with a product in the customer's 102 house 110 (i.e., product X). Additionally, in some embodiments, the database 108 can also include an indication that a product is no longer in the customer's 102 house 110. For example, if a waste or recycling receptacle includes an RFID reader 104 and that RFID reader 104 reads an RFID tag, the control circuit 106 can infer that the customer 102 has disposed of that product. In such a case, the database 108 can include an indication that that product has, or has likely been, disposed of.

At stage H, the control circuit 106 transmits an indication of the recall notification to the customer 102. The control circuit 106 can transmit an indication of the recall notification to the customer 102 in any suitable manner. For example, the control circuit 106 can transmit the indication of the recall notification to the customer 102 via a short message service (SMS) message, a multimedia messaging service (MMS) message, a near field communication (NFC) message, an email, a phone call, etc. Further, the control circuit 106 can transmit the indication of the recall notification directly to the customer 102 (e.g., to the customer's phone) or to an appliance in the customer's 102 house 110. For example, the control circuit 106 can transmit the indication of the product recall for presentation on a television, computer, display device on a refrigerator, etc. The indication of the recall notification can include any suitable information. For example, indication can include an identification of the product with which the recall notification is associated, an indication of the cause of the recall notification, instructions for what to do with the product with which the recall notification is associated, etc. In some embodiments, in addition to transmitting an indication of the recall notification, the control circuit 106 can transmit a confirmation of receipt of the recall notification to the entity from which the recall notification was received (e.g., the supplier, the manufacturer, the retailer, the governmental agency, etc.).

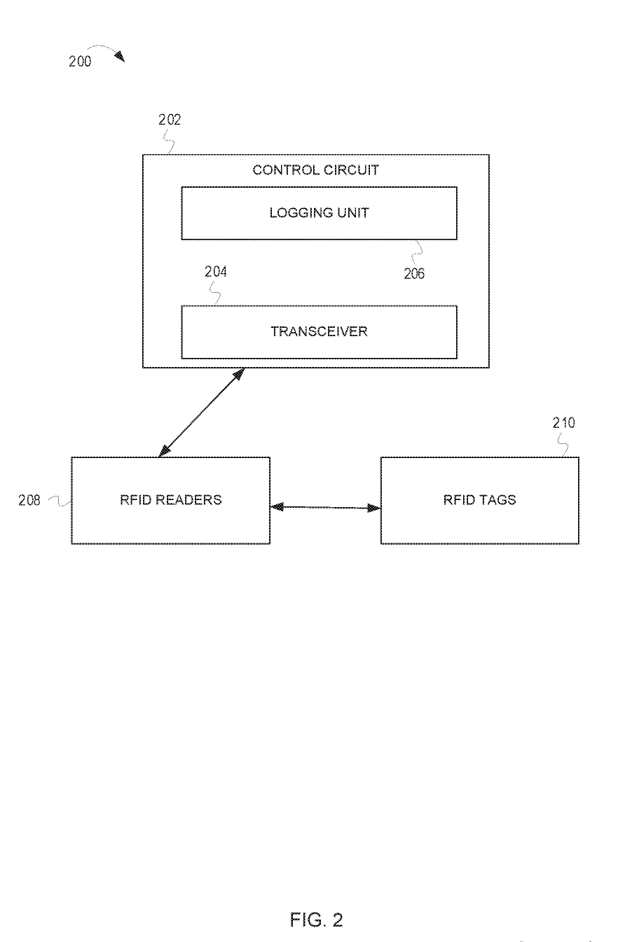

While the discussion of FIG. 1 provides background information regarding a system for providing recall notifications, the discussion of FIG. 2 provides additional details about such a system.

FIG. 2 is a block diagram of a system 200 for providing product recall notifications, according to some embodiments. The system includes a control circuit 202, RFID readers 208, and RFID tags 210. In some embodiments, the control circuit 202 is integrated with a dedicated recall notification device. The control circuit 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 202 is configured (for example, by using corresponding programming as will be well understood by those skilled in the art) to carry out one or more of the steps, actions, and/or functions described herein.

By one optional approach the control circuit 202 operably couples to a memory. The memory may be integral to the control circuit 202 or can be physically discrete (in whole or in part) from the control circuit 202 as desired. This memory can also be local with respect to the control circuit 202 (where, for example, both share a common circuit board, chassis, power supply, and/or housing) or can be partially or wholly remote with respect to the control circuit 202 (where, for example, the memory is physically located in another facility, metropolitan area, or even country as compared to the control circuit 202).

This memory can serve, for example, to non-transitorily store the computer instructions that, when executed by the control circuit 202, cause the control circuit 202 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The RFID readers 208 are located about a customer's property, such as a home, and office, a warehouse, etc. The RFID readers 208 can be located in the property (e.g., in the customer's house) and/or near the property (e.g., outside the customer's house). The RFID readers 208 can be standalone units or integrated into fixtures, appliances, and/or features or the property.

The RFID readers 208 are configured to read the RFID tags 210. The RFID tags 210 can be passive and/or active. The RFID tags 210 are associated with products. When the customer brings a product in or near his or her property, the RFID readers 208 read the RFID tags 210 associated with the products. When the RFID readers 208 read an RFID tag 210, the RFID readers 208 send an identifier of the RFID tag 210 to the control circuit 202. The control circuit 202 includes a transceiver 204 (or, in some embodiments, a receiver). The transceiver 204 receives the identifiers. The control circuit 202, via the logging unit 206, logs the identifiers in a database. In some embodiments, the database includes the identifiers, an indication of the customer, and an indication of a product with which the identifier is associated.

When a recall notification is received, the control circuit 202 determines whether the customer possesses a product with which the recall notification is associated. If the customer possesses the product with which the recall notification is associated, the control circuit 202 transmits an indication of the recall notification to the customer. The indication of the recall notification can include any relevant information about the recall notification, such as an identification of the product with which the recall notification is associated, an indication of the cause of the recall notification, instructions for what to do with the product with which the recall notification is associated, etc.

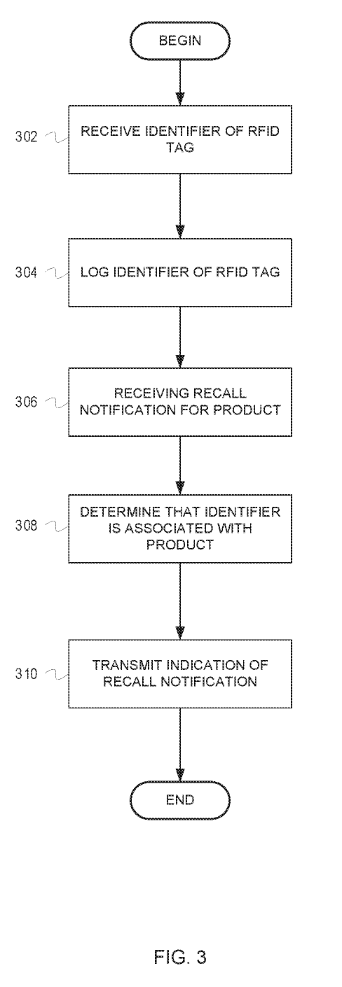

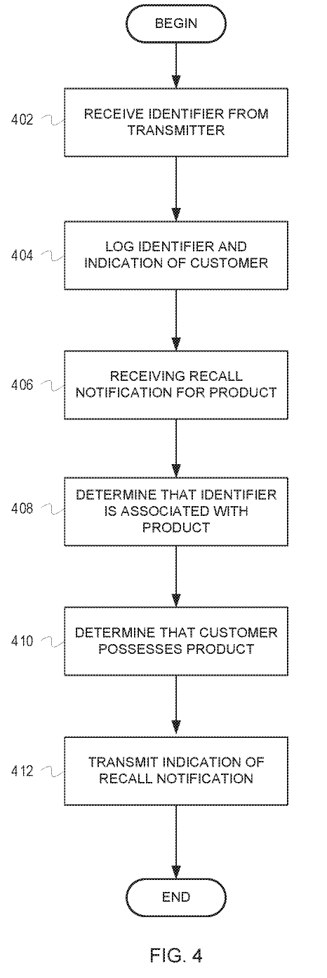

While the discussion of FIG. 2 provides additional information regarding a system for providing recall notifications, the discussion of FIGS. 3 and 4 provide example operations for providing recall notifications.

FIG. 3 is a flow diagram depicting example operations for providing product recall notifications, according to some embodiments. The flow begins at block 302.

At block 302, identifiers of RFID tags are received. For example, a control circuit can receive the identifiers of the RFID tags from RFID readers. The identifiers can identify a product as well as information about the product (e.g., a retailer, a manufacture date, a batch code, etc.). The RFID readers are located about a customer's property. The RFID readers read the RFID tags as the products with which the RFID tags are associated are brought to the customer's property. For example, when the customer returns home from a retail facility, the RFID readers read the RFID tags on the products that the customer has brought home. The flow continues at block 304.

At block 304, the identifiers of the RFID tags are logged. For example, the control circuit can log the identifiers of the RFID tags in a database. The database, as well as the control circuit, can be dedicated to a single customer (e.g., part of a “smart home” system installed in the customer's home). In such embodiments, the information contained in the database can be as minimal as the identifiers. However, in some embodiments, the database can store additional information. For example, the database can store information about the manufacturer or a product, the retailer that sold the product, a production date of the product, a country of origin of the product, or any other useful information about the product. Additionally, the database can store information about the costumer, such as the customer's identity and/or contact information. In some embodiments, the control circuit and/or database can be used to store information related to more than one customer. For example, a retailer, supplier, manufacturer, government entity, or other business can maintain a database and facilitate transmission of recall notifications. The flow continues at block 306.

At block 306, a recall notification is received. For example, the control circuit can receive the recall notification. The control circuit can receive the recall notification from any suitable entity, such as a retailer, a supplier, a manufacturer, a government entity, or other type of business. In one embodiment, the control circuit actively requests recall notifications from one or more providers of recall notifications. In other embodiments, the control circuit receives recall notifications without requesting such notifications. Further, in some embodiments, the control circuit can be configured to receive both push notifications and pull notifications. The recall notifications include information related to the recall. For example, the recall notification can identify a product with which the recall notification is associated, identify a risk or defect associated with the product, identify a portion of products subject to the recall (e.g., based on manufacture date, style, color, country of origin, etc.), or any other suitable information. The flow continues at block 308.

At block 308, it is determined whether an identifier associated with a product possessed by the customer is associated with the recall notification. For example, the control circuit can determine whether an identifier associated with a product possessed by the customer is associated with the recall notification. Put simply, the control circuit determines whether the recall is related to a product possessed by the customer. In some embodiments, the control circuit references the database. Because the database contains identifiers of the products possessed by the customer, if the database includes an identifier associated with the recall notification, it can be assumed that the customer possesses a product that is subject to a recall. The flow continues at block 310.

At block 310, an indication of the recall notification is transmitted. For example, the control circuit can transmit an indication of the recall notification to the customer. The control circuit can transmit an indication of the recall notification via any suitable means. For example, the control circuit can transmit the indication of the recall notification to a mobile device, a computer, an appliance, etc. The indication of the recall notification can include identification of the product with which the recall notification is associated, an indication of the cause of the recall notification, instructions for what to do with the product with which the recall notification is associated, etc.

FIG. 4 is a flow diagram depicting example operations for providing product recall notifications, according to some embodiments. The flow begins at block 402

At block 402, identifiers are received. For example, a control circuit can receive the identifiers from receivers via communications from transmitters associated with products. The receivers are located in and/or around a customer's property (i.e., located about the customer's property). The receivers can be any device suitable for receiving communications from transmitters. For example, the receivers can be low energy radio frequency receivers (e.g., a Bluetooth or ZigBee receiver). In some embodiments, the receivers may be Wi-Fi devices, such as access points or components associated with an access point. In such embodiments, if the product is capable of connecting to a Wi-Fi network, the product can transmit the identifier to the Wi-Fi device upon connection to the Wi-Fi network. The identifiers can identify a product as well as information about the product (e.g., a retailer, a manufacture date, a batch code, etc.). In embodiments in which the receivers are Wi-Fi devices, the identifiers can include MAC addresses or other similar identifying information for the products. The receivers receive identifiers from the transmitters as the products with which the transmitters are associated are brought to the customer's property. For example, when the customer returns home from a retail facility, the receivers receive the identifiers from the transmitters associated with the products that the customer has brought home. The flow continues at block 404.

At block 404, the identifiers and an indication of the customer are logged. For example, the control circuit can log the identifiers and the indication of the customer in a database. The database, as well as the control circuit, can be dedicated to a single customer (e.g., part of a “smart home” system installed in the customer's home). In such embodiments, the information contained in the database can be as minimal as the identifiers (i.e., a specific indication of the customer does not need to be stored in the database as the database dedicated to the customer). In other embodiments, the database can store additional information. For example, the database can store information about the manufacturer or a product, the retailer that sold the product, a production date of the product, a country of origin of the product, or any other useful information about the product. The indication of the customer can be determined explicitly via the communication from the transmitter (e.g., the transmitter transmits the indication of the customer), or be determined inferentially (e.g., the indication of the customer can be determined based on the receiver being associated with the customer and/or the customer's property). The database can store information about the costumer, such as the customer's identity and/or contact information. In some embodiments, the control circuit and/or database can be used to store information related to more than one customer. For example, a retailer, supplier, manufacturer, government entity, or other business can maintain a database and facilitate transmission of recall notifications. The flow continues at block 406.

At block 406, a recall notification is received. For example, the control circuit can receive the recall notification. The control circuit can receive the recall notification from any suitable entity, such as a retailer, a supplier, a manufacturer, a government entity, or other type of business. In one embodiment, the control circuit actively requests recall notifications from one or more providers of recall notifications. In other embodiments, the control circuit receives recall notifications without requesting such notifications. Further, in some embodiments, the control circuit can be configured to receive both push notifications and pull notifications. The recall notifications include information related to the recall. For example, the recall notification can identify a product with which the recall notification is associated, identify a risk or defect associated with the product, identify a portion of products subject to the recall (e.g., based on manufacture date, style, color, country of origin, etc.), or any other suitable information. The flow continues at block 408.

At block 408, it is determined that the recall notification is associated with a specific product. For example, the control circuit can determine with which product the recall notification is associated. As noted above, in some embodiments, the recall notifications can identify a product with which the recall notification is associated. For example, the recall notification can include information about the product, such as the name of the product, the type of the product, a manufacturing facility at which the product was manufactured, a retailer from which the product was purchased, a manufacture date of the product, a serial number or other identifier associated with the product, etc. The flow continues at block 410.

At block 410, it is determined that the customer possesses the product. For example, the control circuit can determine that the customer possesses the product with which the recall notification is associated. That is, the control circuit can determine whether an identifier associated with a product possessed by the customer is associated with the recall notification. In some embodiments, the control circuit references the database. Because the database contains identifiers of the products possessed by the customer, if the database includes an identifier associated with the recall notification, it can be assumed that the customer possesses a product that is subject to a recall. The flow continues at block 412.

At block 412, an indication of the recall notification is transmitted. For example, the control circuit can transmit an indication of the recall notification to the customer. The control circuit can transmit an indication of the recall notification via any suitable means. For example, the control circuit can transmit the indication of the recall notification to a mobile device, a computer, an appliance, etc. The indication of the recall notification can include identification of the product with which the recall notification is associated, an indication of the cause of the recall notification, instructions for what to do with the product with which the recall notification is associated, etc.

In some embodiments, a system for providing recall notifications comprises a plurality of receivers, wherein the plurality of receivers are located about a customer's property, and wherein the plurality of receivers are configured to receive communications from transmitters associated with products within the customer's property, and a control circuit communicatively coupled to the plurality of receivers and configured to receive, in response to the customer bringing the products into the customer's property from one or more of the plurality of receivers, identifiers associated with the products, log, in a database, an indication of the identifiers and an indication of the customer, receive a recall notification, wherein the recall notification indicates at least one product, determine, based on the database, that the customer possess the at least one product, and transmit an indication of the recall notification for the at least one product.

In some embodiments, an apparatus and a corresponding method performed by the apparatus comprises receiving, at a control circuit from one or more receivers of a plurality of receivers located about a customer's property, identifiers of from transmitters associated with products when the customer brings the products into the customer's property, logging, in a database, the identifier and an indication of the customer, receiving, at the control circuit, a recall notification, wherein the recall notification indicates at least one product, determining, by the control circuit based on the database, that the identifier is associated with the at least one product, determining, by the control circuit based on the database, that the customer possesses the at least one product, and transmitting an indication of the recall notification.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for automatically providing recall notifications to a customer, the system comprising:
a plurality of receivers, wherein the plurality of receivers is located about a customer's property, and wherein the plurality of receivers is configured to receive communications from transmitters associated with products within the customer's property; and
a control circuit communicatively coupled to the plurality of receivers and configured to:
receive, in response to the customer bringing the products into the customer's property from one or more of the plurality of receivers, identifiers associated with the products;
log, in a database, an indication of the identifiers and an indication of the customer;
receive a recall notification, wherein the recall notification indicates at least one product;
determine, based on the database, that the identifier is associated with the at least one product;
determine, based on the database, that the customer possesses the at least one product; and
transmit, to the customer, an indication of the recall notification for the at least one product.

2. The system of claim 1, wherein the control circuit is located within the customer's property.

3. The system of claim 2, wherein the control circuit is integrated with a dedicated recall notification device.

4. The system of claim 1, wherein the control circuit is remote from the customer's property.

5. The system of claim 1, wherein at least some of the plurality of receivers are integrated with appliances.

6. The system of claim 1, wherein the control circuit receives the recall notification from one or more of a manufacturer and a retailer.

7. The system of claim 1, wherein the control circuit transmits the indication of the recall notification to an appliance.

8. The system of claim 1, wherein the control circuit transmits the indication of the recall notification to the customer via one or more of a short message service (SMS) message, a multimedia messaging service (MMS) message, a near field communication (NFC) message, and an email.

9. The system of claim 1, wherein the indication of the recall notification identifies the at least one product indicated by the recall notification.

10. The system of claim 1, wherein the control circuit is further configured to:
transmit, to one or more of a retailer of the at least one product indicated by the recall notification and a manufacturer of the at least one product indicated by the recall notification, a confirmation of receipt of the recall notification.

11. A method for automatically providing recall notification to a customer, the method comprising:
receiving, at a control circuit from one or more receivers of a plurality of receivers located about a costumer's property, identifiers from transmitters associated with products when the customer brings the products into the customer's property;
logging, in a database, the identifier and an indication of the customer;
receiving, at the control circuit, a recall notification, wherein the recall notification indicates at least one product;
determining, by the control circuit based on the database, that the identifier is associated with the at least one product;
determining, by the control circuit based on the database, that the customer possesses the at least one product; and
transmitting, to the customer, an indication of the recall notification for the at least one product.

12. The method of claim 11, wherein the control circuit is located within the customer's property.

13. The method of claim 12, wherein the control circuit is integrated with a dedicated recall notification device.

14. The method of claim 11, wherein the control circuit is remote from the customer's property.

15. The method of claim 11, wherein at least some of the plurality of receivers are integrated with appliances.

16. The method of claim 11, wherein the control circuit receives the recall notification from one or more of a manufacturer and a retailer.

17. The method of claim 11, wherein the transmitting the indication of the recall notification comprises transmitting the indication of the recall notification to an appliance.

18. The method of claim 11, wherein indication of the recall notification is transmitted via one or more of a short message service (SMS) message, a multimedia message service (MMS) message, a near field communication (NFC) message, and an email.

19. The method of claim 11, wherein the indication of the recall notification identifies the at least one product indicated by the recall notification.

20. The method of claim 11, further comprising:
transmitting, to one or more of a retailer of the at least one product indicated by the recall notification and a manufacturer of the at least one product indicated by the recall notification, a confirmation of receipt of the recall notification.
